(19) United States
(12) Patent Application Publication
(10) Pub. No.: US 2019/0003268 A1
(43) Pub. Date: Jan. 3, 2019

(54) Systems, Devices, and/or Methods for Managing Well Pumps

(71) Applicant: David A. Harold, Rustburg, VA (US)

(72) Inventor: David A. Harold, Rustburg, VA (US)

(21) Appl. No.: 16/025,898

(22) Filed: Jul. 2, 2018

Related U.S. Application Data
(60) Provisional application No. 62/528,355, filed on Jul. 3, 2017.

(51) Int. Cl. E21B 19/00; E21B 19/22; B66D 1/34; B66D 1/12

(52) U.S. Cl. CPC E21B 19/008; B66D 1/12; B66D 1/34; E21B 19/22

(57) ABSTRACT

Certain exemplary embodiments can provide a reel, which defines a center aperture. The reel can be coupled to a motor and/or drive system, which can cause the reel to rotate. The motor and/or drive system has a relatively low output rotational speed of less than approximately 10 revolutions per minute. Once coupled, a flexible tube (e.g., a plastic tube and/or hose) that is coupled to a well pump can wrap around the reel and thereby lift a pump coupled to the flexible tube out of the ground.

### CROSS-REFERENCE TO RELATED APPLICATIONS

The patent or application file contains at least one drawing executed in color. Copies of this patent or patent application publication with color drawings will be provided by the Office upon request and payment of the necessary fee. This application claims priority to, and incorporates by reference herein in its entirety, pending U.S. Provisional Patent Application Ser. No. 62/528,355 (Attorney Docket No. 1223-01), filed Jul. 3, 2017.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 100;

FIG. 1A is a perspective view of an exemplary embodiment of reel 1000;

FIG. 2 is a plan view of exemplary reel 1000;

FIG. 3 is a color photograph of exemplary reel 1000;

FIG. 4 is a color photograph of exemplary reel 1000; and

FIG. 5 is a flowchart of an exemplary embodiment of a method 5000.

### DETAILED DESCRIPTION

Certain exemplary embodiments can provide a reel, which defines a center aperture. The reel can be coupled to a motor and/or drive system, which can cause the reel to rotate. The motor and/or drive system has a relatively low output rotational speed of less than approximately 10 revolutions per minute. Once coupled, a flexible tube (e.g., a plastic tube and/or hose) that is coupled to a well pump can be gripped by and/or wrap around the reel and thereby lift a pump coupled to the flexible tube out of the ground.

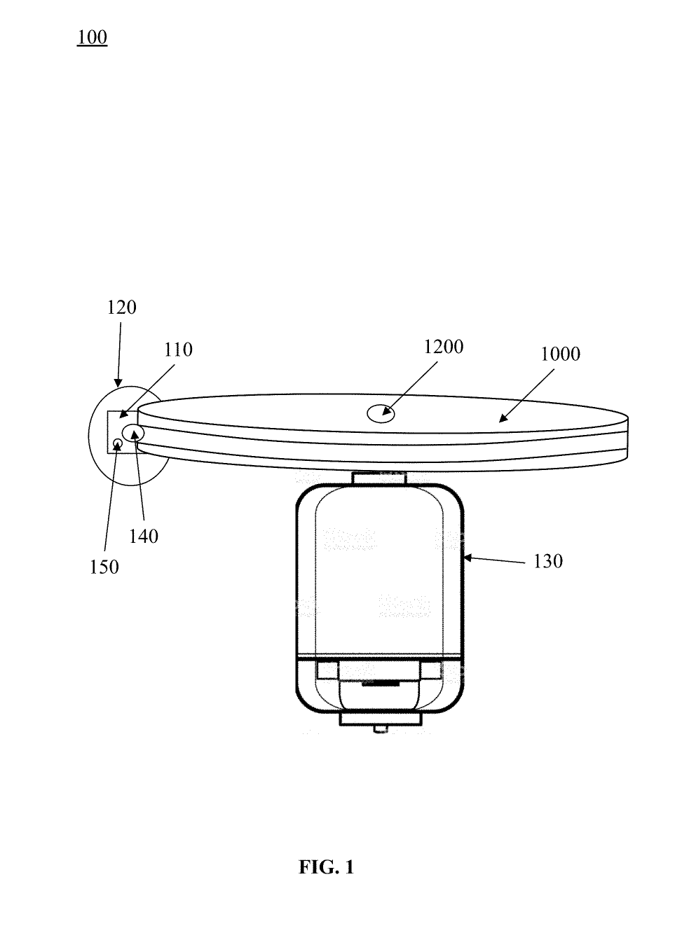

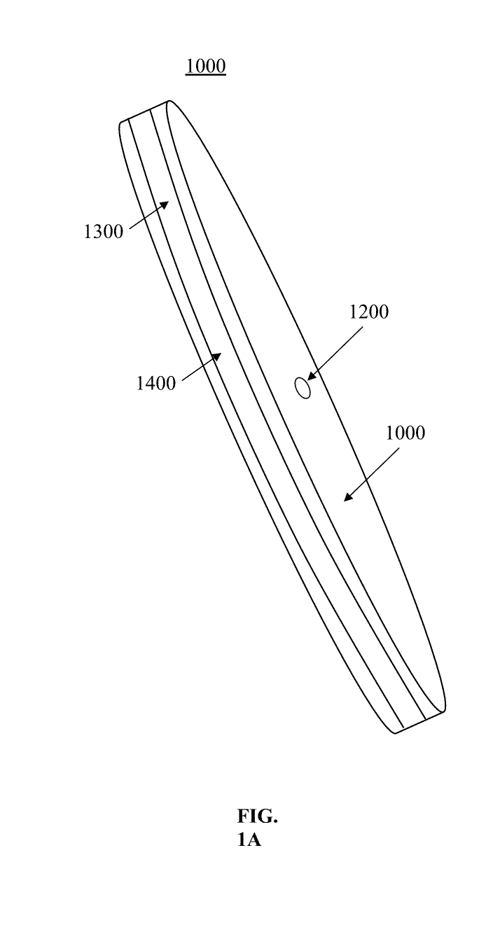

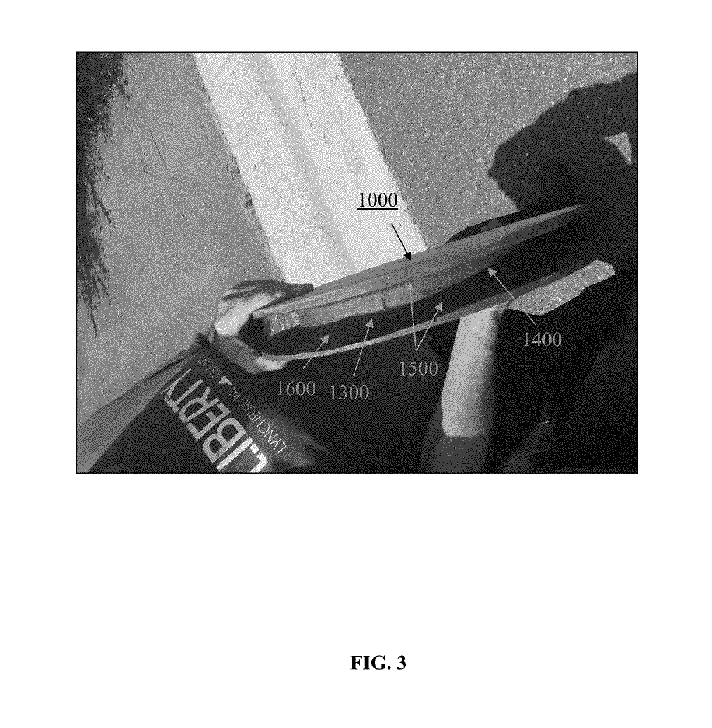

FIG. 1 is a block diagram of an exemplary embodiment of a system 100. Certain exemplary embodiments comprise a reel 1000 constructed to remove a well pump 110 from a well 120. Reel 1000 defines a center aperture 1200 and comprises a tapered groove (see tapered groove 1300 shown in FIG. 3). The tapered groove comprises grit (see grit 1400 shown in FIG. 3) applied to the tapered groove (see tapered groove 1300 shown in FIG. 3).

System 100 comprises a motor 130 coupleable to reel 1000 via center aperture 1200. In certain exemplary embodiments, the motor is constructed to rotate reel 1000 at a rotational speed of less than approximately 10 revolutions per minute. In certain operative embodiments, a flexible tube and/or pipe 140 that is coupled to well pump 110 is gripped by reel 1000, thereby lifting well pump 110 coupled to flexible tube and/or pipe 140 out of the ground. In certain exemplary embodiments, motor 130 is coupled to reel 1000 via a drive system. For example, the drive system can be sheave drive that comprises a drive belt. In other embodiments, the drive system can comprise sprockets and a chain. In other embodiments, motor 130 can be powered by an electrical drive constructed to cause motor 130 to rotate at a variable rotational speed. Flexible tube and/or pipe 140 can be a plastic tube or hose. In certain operative embodiments, a safety line 150 coupled to well pump 110 can be gripped by reel 1000, thereby lifting well pump 110 out of the ground.

FIG. 1A is a perspective view of an exemplary embodiment of reel 1000. Reel 1000 defines a center aperture 1200, via which a motor and/or drive system can be coupled to reel 1000. For example, a motor and/or drive system that has a relatively low output rotational speed (e.g., less than approximately 10 revolutions per minute can be coupled to reel 1000. Once coupled, a flexible tube (e.g., a plastic tube and/or hose) that is coupled to a well pump can be gripped by and/or wrap around reel 1000 and thereby lift a pump coupled to the flexible tube out of the ground.

Reel 1000 defines a tapered groove 1300, which can have grit 1400 applied to the tapered surfaces in order to better grip the flexible tube. Tapered groove 1300 can be sized such that flexible tubes having nominal diameters of ¾ inch, one inch, and 1½ inch can be lifted via reel 1000. When retrieving a pump from a well, the flexible tube might not wrap around reel 1000. Instead, the flexible tube will be gripped by and drawn across tapered groove 1300 substantially continuously until the pump is raised from the well. In some circumstances, the flexible tube might break and/or otherwise become disconnected by the pump such that the pump cannot be raised via the flexible tube. Under such circumstances, pumps in wells generally have a safety line coupled to them. The safety line can be wrapped around reel 1000 reel 1000 can then be rotated to retrieve the pump from the well.

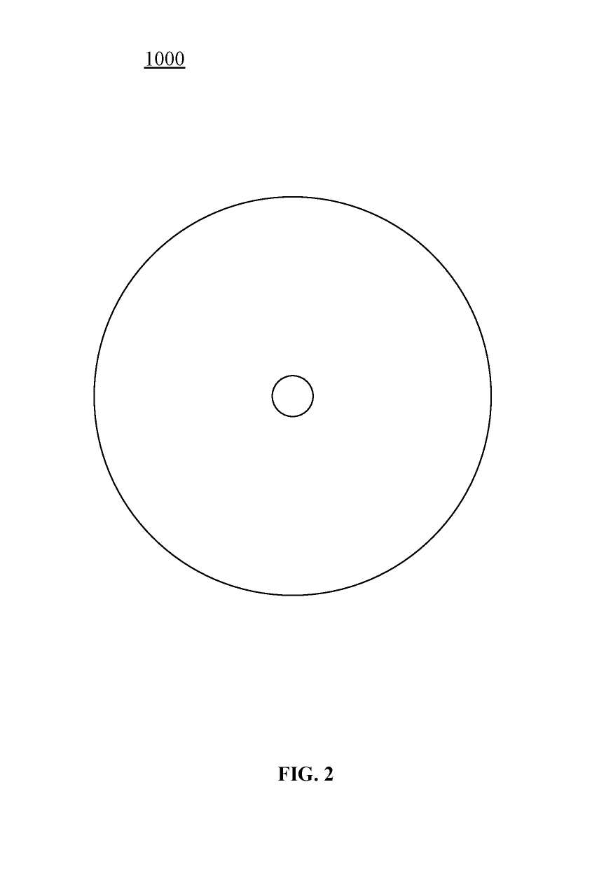

FIG. 2 is a plan view of exemplary reel 1000. The perspective view of FIG. 2 illustrates center aperture 1200.

FIG. 3 is a color photograph of a perspective view of exemplary reel 1000. FIG. 3 shows tapered groove 1300 with grit 1400 applied to the tapered surfaces from a different perspective. Tapered groove 1300 comprises a base 1600 and a pair of sides 1500.

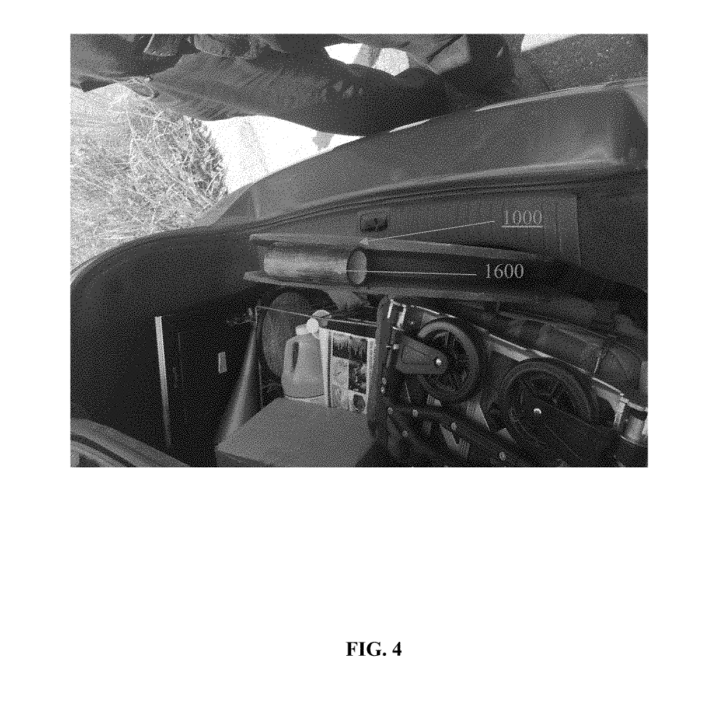

FIG. 4 is a color photograph of exemplary reel 1000. A section of hose 1600 is of a size that can be gripped, reeled in, and/or reeled out via reel 1000.

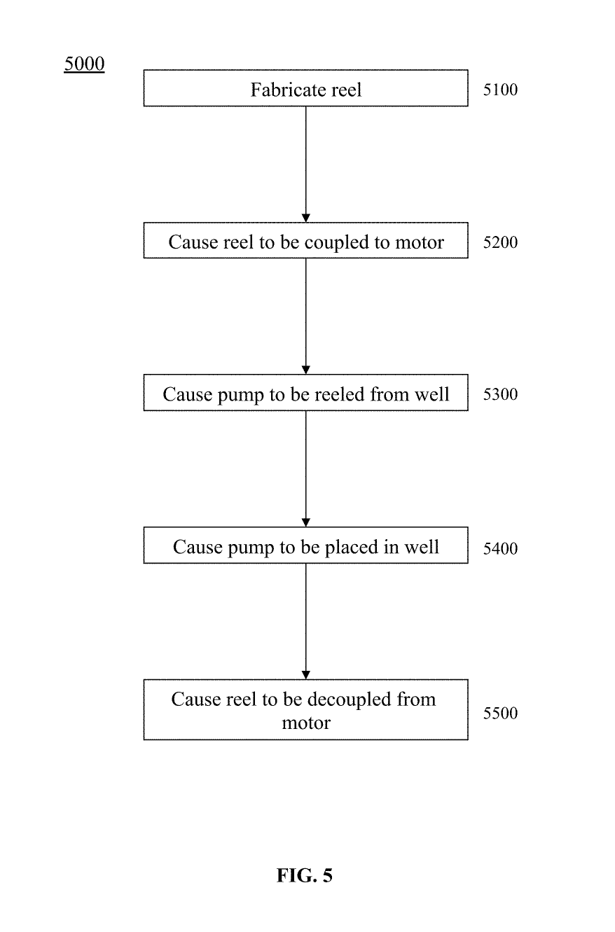

FIG. 5 is a flowchart of an exemplary embodiment of a method 5000. At activity 5100, a reel can be fabricated. At activity 5200, certain exemplary embodiments comprise causing the reel to be coupled to a motor. Certain exemplary embodiments can cause a reel to be coupled to a motor and a flexible well pump pipe. The motor causes the reel to rotate and rolls the well pump pipe on and/or off the reel, thereby raising a well pump from a well or lowering the well pump into the well.

At activity 5300, certain exemplary embodiments comprise causing a pump to be reeled from a well. At activity 5400, certain exemplary embodiments comprise causing the pump to be placed in the well. At activity 5500, certain exemplary embodiments comprise causing the reel to be decoupled from the motor.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapter—a device used to effect operative compatibility between different parts of one or more pieces of an apparatus or system.
and/or—either in conjunction with or in alternative to.
apparatus—an appliance or device for a particular purpose
associate—to join, connect together, and/or relate.
can—is capable of, in at least some embodiments.
comprising—including but not limited to.
configure—to make suitable or fit for a specific use or situation.
connect—to join or fasten together.
constructed to—made to and/or designed to.
convert—to transform, adapt, and/or change.
coupleable—capable of being joined, connected, and/or linked together.
coupling—linking in some fashion.
define—to establish the outline, form, or structure of
determine—to obtain, calculate, decide, deduce, and/or ascertain.
device—a machine, manufacture, and/or collection thereof.
install—to connect or set in position and prepare for use.
may—is allowed and/or permitted to, in at least some embodiments.
method—a process, procedure, and/or collection of related activities for accomplishing something.
plurality—the state of being plural and/or more than one.
predetermined—established in advance.
project—to calculate, estimate, or predict.
provide—to furnish, supply, give, and/or make available.
pump—a device and/or system constructed to raise and/or transfer liquids.
receive—to get as a signal, take, acquire, and/or obtain.
reel—a frame that turns on an axis and is used to wind up or pay out something.
remove—to shift from one place or position to another.
repeatedly—again and again; repetitively.
request—to express a desire for and/or ask for.
set—a related plurality.
store—to place, hold, and/or retain data, typically in a memory.
substantially—to a great extent or degree.
support—to bear the weight of, especially from below.
system—a collection of mechanisms, devices, machines, articles of manufacture, processes, data, and/or instructions, the collection designed to perform one or more specific functions.
via—by way of and/or utilizing.
well—a hole drilled or bored into the earth to obtain water.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a reel constructed to remove a well pump from a well, the reel defining a center aperture and comprising a tapered groove, the tapered groove comprising grit applied to the tapered groove; and
a motor coupleable to the reel via the center aperture, wherein:
the motor is constructed to rotate the reel at a rotational speed of less than 10 revolutions per minute; and
in operative embodiments, a flexible tube that is coupled to the well pump is gripped by the reel, thereby lifting the well pump coupled to the flexible tube out of the ground.

2. The device of claim 1, wherein:
the motor is coupled to the reel via a drive system.

3. The device of claim 1, wherein:
the flexible tube is a plastic tube or hose.

4. A system comprising:
a reel constructed to remove a well pump from a well, wherein the reel defines a center aperture; and
a motor coupleable to the reel via the center aperture, wherein:
the motor is constructed to rotate the reel at a rotational speed of less than 10 revolutions per minute; and
in operative embodiments, a safety line that is coupled to a well pump is gripped by the reel, thereby lifting the well pump out of the ground.

5. A method comprising:
causing a reel to be coupled to a motor and a flexible well pump pipe, wherein the motor causes the reel to rotate and roll the well pump pipe on or off the reel, thereby raising a well pump from a well or lowering the well pump into the well.

6. The method of claim 5, further comprising:
fabricating the reel.

7. The method of claim 5, further comprising:
causing the pump to be reeled from the well.

8. The method of claim 5, further comprising:
causing the reel to be decoupled from the motor.
